(19) United States
(12) Patent Application Publication
(10) Pub. No.: US 2005/0286546 A1
(43) Pub. Date: Dec. 29, 2005

(54) Synchronized media streaming between distributed peers

(76) Inventors: Arianna Bassoli, Modena (IT); Julian Desmond Moore, Limerick (IE); Stefan Panayiotis Agamanolis, Akron, OH (US)

Correspondence Address: CHARLES G. CALL, 68 HORSE POND ROAD, WEST YARMOUTH, MA, 02673-2516, US

(21) Appl. No.: 11/157,464

(22) Filed: Jun. 21, 2005

Related U.S. Application Data
(60) Provisional application No. 60/581,466, filed on Jun. 21, 2004.

(51) Int. Cl. H04L 12/16; H04J 3/06

(52) U.S. Cl. 370/432; 370/503; 370/260

(57) ABSTRACT

Methods and apparatus for providing synchronous playback of the same piece of time-based media on multiple devices connected over heterogenous channels consisting of varying degrees of delay. The preferred embodiment of the invention is a handheld music player that uses a Wi-Fi or Bluetooth communications link to enable users to share music with similar nearby players and to synchronously play back the same music different players simultaneously. Users of all players tuned into one source hear the same thing at the same time, enabling the feeling of a shared music experience. Users can also use their players to exchange profile information and text messages.

### CROSS REFERENCE TO RELATED APPLICATION

This application is a non-provisional of U.S. Provisional Patent Application 60/581,466 filed on Jun. 21, 2004. This application claims the benefit of the filing date of that provisional application and incorporates its disclosure herein by reference.

### FIELD OF THE INVENTION

This invention relates to social networking devices and systems and more particularly to methods and apparatus for providing a shared experience of music or other time-based media to two or more people who might be near one another.

### BACKGROUND OF THE INVENTION

Peer-to-peer Internet-based applications allow users to share their resources without the aid of central servers. Technologies like Wi-Fi, Bluetooth, mobile phones and PDAs have made it possible to form peer-to-peer networks in mobile settings. These are expected to have a growing impact on the way people communicate and exchange information and ideas with each other, and on social and cultural behaviors in general.

The term “Mobile ad hoc social network” describes the new social form made possible by the combination of computational, communication, reputation, and location awareness. The “mobile” aspect is already self-evident to urbanites who see the early effects of mobile phone voice communications and SMS messaging. “Ad hoc” refers to the ability of short range communication capabilities to establish location-based networks between nearby devices informally and on the fly. The term “social network” suggests that every individual connected by the ad hoc network becomes a member of “a smart mob,” and is a “node” in a network of “social links” (channels of communication and social bonds) with other individuals.

Mobile, handheld devices which are currently available are capable of peer-to-peer interaction with other nearby devices can be used as nodes of mobile ad hoc social networks. The present invention uses such devices, with suitable additional programming, to permit socialization by sharing music and other information among nearby individuals on a tightly synchronized basis to create a shared experience.

There has been growing interest in using network infrastructures like the Internet or peer-to-peer technologies like those outlined above for delivery of radio, TV programs, and other time-based media content, many forms of which used to be transmitted to viewers/listeners using conventional analog broadcasting techniques that inherently enabled synchronous viewing/listening among those in range of the transmission.

While they provide certain advantages over conventional broadcasting techniques, these new kinds of channels do not inherently support synchronous experiences because of varying delays that exist in the channels between a media source and the output of the media on connected receivers. This delay arises from any number of factors, including delays introduced at each hop in packet-switched networks as well as delays introduced by the operating systems and other software processing the media in transmission.

### SUMMARY OF THE INVENTION

Preferred embodiments of the invention provide synchronous playback of the same piece of time-based media on multiple devices connected over a channel to a source for that media, thereby creating a shared experience of that media among those who are experiencing it on those devices, no matter where they may be with respect to each other and the source.

The word “channel” here is meant to encompass not only the network involved (wired or wireless) but the operating system and any software modules acting on the data at both ends and any points between the source and the receivers. Each receiver might be connected to the source over a different channel incurring a different amount of delay. The channel might involve wired or wireless networks, and might also involve hops through one or more of the receiver devices. The receivers themselves might be handheld mobile devices or any other kind of device or set of devices acting in coordination.

The phrase “time based media” here refers to media forms that are meant to be experienced over a certain interval of time. Music and television programs would be examples of time-based media, as well as things like MIDI files, videogame events, theatrical lighting events, other aural and/or visual media, and other media forms or combinations thereof that are meant to play back over a defined time interval.

The invention is preferably implemented by using information about the amount of delay (measured by any number of established means) in the channels between a media source and any number of media receivers to synchronize media playback on those receivers. Each of these receivers might be experiencing different amounts of raw delay from the source, and the devised method works by introducing varying amounts of additional artificial delay at each receiver so that the final delay experienced by each receiver is the same.

The specific embodiment to be described employs a peer-to-peer wireless application that allows users to share music locally through handheld devices. Users can “tune in” to other nearby music players (here called “tunA” players) and listen to what someone else is listening to; the application displays a list of people using tunA that are in range, gives access to their profile and playlist information, and enables synchronized peer-to-peer audio streaming. Music and other kinds of audio recordings are the “time based media” handled by this implementation.

The tunA devices connect people at a local scale, through the creation of dynamic and ad-hoc wireless networks. The tunA players allow users to listen to what other people in physical proximity are listening to, synchronized to enable the feeling of a shared experience.

Any kind of wireless handheld device now widely used as portable music players can be modified to implement the invention. The experience that tunA provides to users is the opportunity to feel connected to people around while listening to music and moving in a physical environment. This specific application is mainly targeted to teenagers and designed for social dynamics happening in urban environments, but it can accommodate a number of different usages and scenarios.

### BRIEF DESCRIPTION OF THE DRAWINGS

In the detailed description which follows, frequent reference will be made to the attached drawings, in which:

FIG. 1 is a block schematic diagram illustrating the relationship between the principal functional components of a music player that can be used to implement the invention;

FIG. 2 is a flowchart illustrating how different players recognize and communicate with one another;

FIG. 3 is a flowchart illustrating how a player multicasts music content and identification information to other players;

FIG. 4 is a flowchart illustrating how players synchronize the music being played so that different players play the same sounds at the same time;

FIG. 5 illustrates the contents of a player's display screen in the “Listening to my own music” mode;

FIG. 6 illustrates the contents of a player's display screen in the “Tuning in to another's music” mode;

FIG. 7 illustrates the contents of a player's display screen in the “Finding out who else is in range” mode; and

FIG. 8 illustrates the contents of a player's display screen in the “Exchanging instant messages” mode.

### DETAILED DESCRIPTION

Introductory Overview

The preferred embodiment of the invention is a hand-held music player called “tunA” that permits its user to share music with other tunA users who are nearby. The device is characterized by the following attributes:

Shared music experience: A person can listen to their own music as they would using conventional portable MP3 or CD player, but they can also tune in and listen to the same music and programming other people are listening to on their tunA devices, resulting in a shared music experience.

Audio synchronization: An audio stream timing/delay algorithm enables the audio playback to be perfectly synchronized on a source player and any nearby destination player, so that people tuned into a particular person's device can be listening to exactly what that other person is listening to. For example, two or more people in a gathering, each holding their own tunA player, can all tune to one of the players, and all of them can be nodding their heads, gesturing, or dancing in perfect synchrony, just as if they were all listening to the same conventional broadcast radio station.

Handheld devices: The device itself is small and meant to be holdable in the hand, like a Walkman, iPod, or other such music player.

Ad-hoc local wireless network connectivity: The tunA devices communicate and stream MP3 encoded audio via channels that involve an ad-hoc 802.11b or Bluetooth wireless network connections.

Multi-hop connectivity/synchronization: A person (X) might tune into someone else (Y) that in turn is tuned into someone else (Z) who is out of range of the original person (X), and the experience would remain synchronized for all three individuals.

Personal profile: Users can store personal profile information in their tuna players and set permissions which specify what information can be shared with other tunA players that might be tuning in.

Bookmarking a song: tunA users can “bookmark” a song that they hear while tuned into someone else's player, and later review these bookmarks, or download them to a computer where they might purchase the song for themselves.

Bookmarking a person: tunA users can “bookmark” another person they've come into contact with through tuna, and be notified if that person comes into range again. These bookmarks can also be downloaded to a regular computer where they might communicate with the other person via email or other means (if the bookmarked person's profile provided this information).

Instant messaging: tunA users can send instant messages, similar to SMS (Short Message Service) text messages sent via digital GSM cellular networks, to each other while they are in range. A tunA user can set preferences controlling if incoming instant messages will be allowed from anyone, just from people they know, or not at all.

Buying, selling, sharing songs: tuna users could purchase new songs in the conventional way from web-based song download sites (like iTunes) or via services offering songs for sale via a wireless ad hoc network; for example, a record store might make songs available for purchase by tunA users in, or standing near, the store.

tunA interface is “skinnable.” The control interface employed by the tunA device consists of a touch screen in combination with displayed controls which include tabs and pushbuttons. One screen shows a list of other users who are carrying other tunA players that are in range, along with information about each in-range device that include, for example: (a) profile information about the user; (b) an identification of the song currently being played on that player; and (c) a playlist of songs stored on the other tunA player that are coming up for playback after the current song. Other display screens provide control of the local player and include the same kinds of controls typically found on portable music players for song selection and playback control (pause, forward, rewind, skip to next, etc.). Additional screen controls allow the user to edit their profile and edit the preference specifying how and when profile information and audio files are to be shared. (profile, song currently played). Other display screens permit the user to keep a list of favorites (people and songs), and to chat with other users in range through an Instant Messaging tool.

Implementation

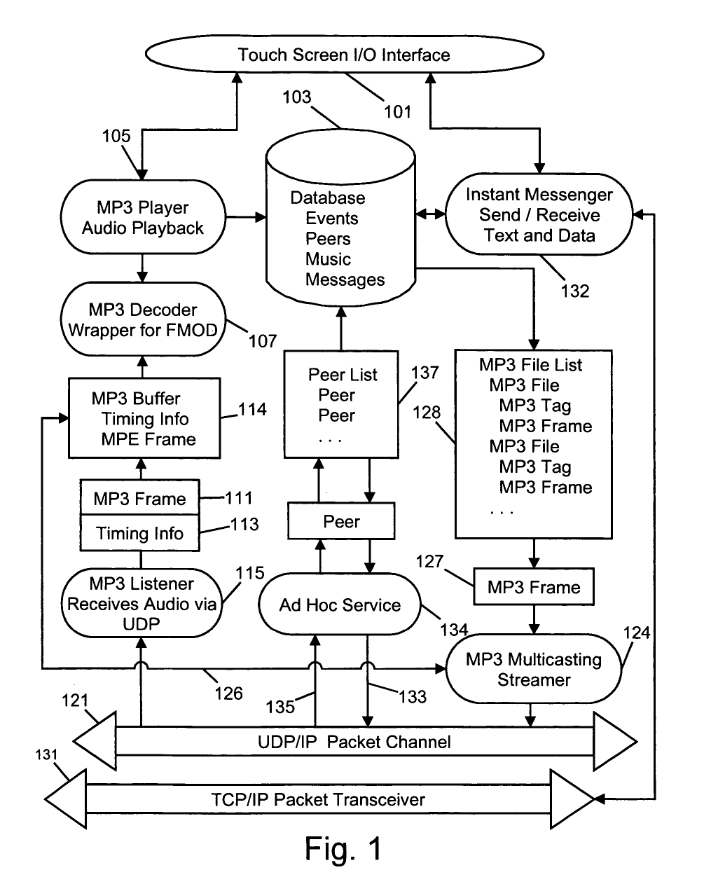

The principal functional components of a tunA player are shown in FIG. 1.

The tunA player may be implemented using the hardware components available in a typical PDA capable of wireless communication using the Wi-Fi (802.11b) protocol, such as a Wi-Fi enabled iPaq 4150 Pocket PC manufactured by Hewlett Packard. “Wi-Fi” (Wireless Fidelity) is the Wireless Ethernet Compatibility Alliance's (WECA) brand identity for the IEEE 802.11b standard. The players may alternatively communicate using built in Bluetooth transceivers. “Bluetooth” designates a technical industry standard that facilitates communication between wireless devices such as mobile phones, PDAs (personal digital assistants) and handheld computers, and wireless enabled laptop or desktop computers and peripherals. A single Bluetooth-enabled wireless device is capable of making phone calls, synchronizing data with desktop computers, sending and receiving faxes, and printing documents. Bluetooth devices use a microchip transceiver that operates on the 2.45 GHz frequency and have a range of up to 10 meters (approximately 33 feet) and are hence suitable for establishing ad hoc social networks between players carried by people in small gathering.

The iPaq 4150 provides communications capabilities using integrated WLAN 802.11b and Bluetooth wireless technology, and well as an IrDA infrared link. The device includes a built in Intel 400 MHz processor and 64 MB of SDRAM, 55 MB of which is user accessible. The device further incorporates a transflective 3.5 inch TFT liquid crystal display with LED backlight providing 64K colors at 240×320 resolution, and provides a pen and touch interface. Built in audio capabilities include an integrated microphone, speaker, and a headphone jack for delivering MP3 stereo. The device is designed to be hand held (dimensions: 4.47 inches by 2.78 inches by 0.53 inches, and weighing 4.67 ounces). Software provided with the device includes the Microsoft Windows Mobile 2003 OS for Pocket PC, a voice recorder, an Internet Explorer Web browser, the Windows Media Player 9 (MP3, audio and video streaming), a volume control, iPAQ File Store, Bluetooth Manager, iPAQ iTask Manager, and other utilities.

The handheld wireless computing device is programmed to provide the functional modules or objects which communicate with one another as illustrated in FIG. 1.

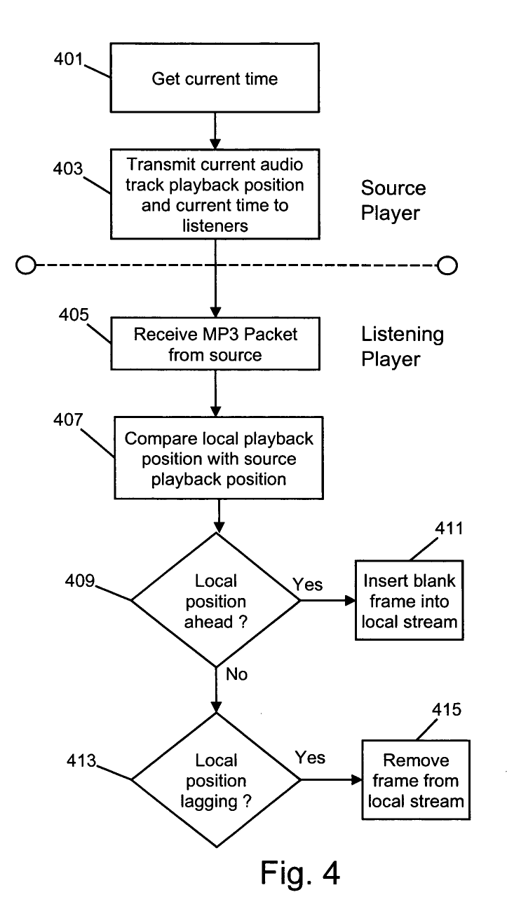

The device is programmed to provide a user interface 101 that employs the touch screen display of the host device to accept input commands from a user and to display output information and visual controls as discussed in more detail below in conjunction with FIGS. 4-7.

Commands accepted from the user by the interface 101 control the selection and reproduction (playback) of audio files stored in a database 103 as indicated at 105. Audio files recorded in the MP3 format, which are referred to herein as “songs,” typically consist of recorded music performances, but may contain other types of audio programming including news and information programming and are stored as separate named filed in the OS file system. These named files may be identified by name in database records, including playlists, stored in the database 103. The database 103 maintains records for all peers, events, audio files, and messages encountered by the system.

During playback, a selected audio file is processed by an MP3 decoder 107 for playback. The MP3 decoder also accepts MP3 data frames 111 and timing information 113 from a buffer control unit 114 that stores this data received by an MP3 “listener” 115 as UDP packets which are transmitted via a wireless Wi-Fi or Bluetooth link from nearby players, or plays back UDP packets that are being sent to nearby players via the UDP channel 121. When the player is playing back a song that is also being transmitted via the UDP channel 121, the transmitted song packets are processed by the listener 115 for playback via the buffer 114. As discussed later, timing information specifying the rate at which the UDP packets are being played back is passed from the playback buffer 114 to the output streamer module 124 as indicated at 126. The multicasting output streamer 124 received packetized MP3 frames 127 from data management subsystem 128 which maintains an MP3 file list that includes metadata “tags” describing each song as well as audio content MP3 frames. The timing information which synchronizes the rate at which MP3 frame data is transmitted via the output streamer 124 is obtained from the MP3 playback buffer control 114 to synchronize playback between the local and remote players that are “listening in.”

The UDP channel 124 may be implemented using the User Datagram Protocol, a connectionless protocol that, like TCP, runs on top of IP networks which can be physically implemented using the Wi-Fi or Bluetooth transceiver in the hand held device. As discussed later, the system also employs a TCP/IP protocol to provide a second communications channel indicated at 131 for communicating text and data between devices via an “Instant Messenger” module 132. The IM component seen at 142 exchanges profile data including avatar image data and the text of chat messages over the separate TCP/IP connection 131. The TCP/IP connection 131 is formed when the discovery service detects that two peers are within range. A simple chat protocol is then used to exchange play-list information, instant messages, and other binary information.

A tunA player discovers like players that are within range, and establishes communications with those players, by periodically multicasting packets announcing their presence to all nearby devices via the UDP channel 124 as indicated at 133. Incoming announcement packets are periodically received by the ad hoc service module 134 from each nearby player that is within the wireless range of the Wi-Fi or Bluetooth transceiver. Each player maintains a list 137 of those peer devices from whom it has detected similar packets within a specified time.

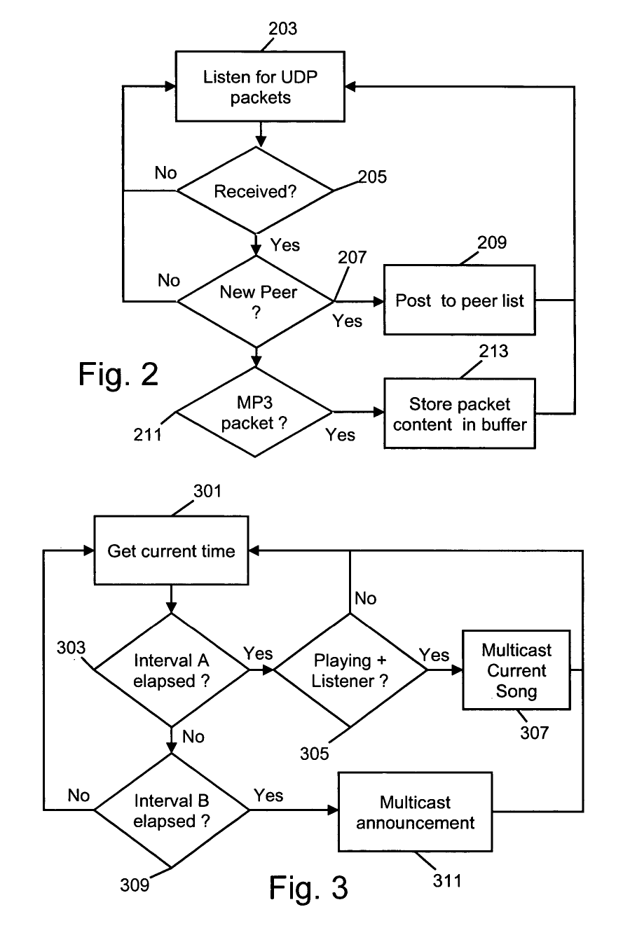

The process executed to monitor the arrival and departure of nearby devices is illustrated in the flowchart of FIG. 2. The ad hoc service seen at 134 in FIG. 1 listens for incoming UDP packets on the channel 137 as indicated at 203 in FIG. 2. When a received packet is detected at 205, its contents are examined at 207 to determine if it is a peer announcement packet and, if it is, the peer list seen at 137 in FIG. 1 is checked to see if the received packet identifies a player already known to be nearby. If not, the identification of the newly arrived player is posted as seen at 209 to the peer list. If the packet identifies a previously posted device, the “last detected” time for that player is updated on the peer list. Any player which has been last detected within a predetermined duration is deemed to be in range.

When a newly arriving player is detected, the IM communication module 132 requests profile information, including a photograph or avatar image, from the newly arriving player. The requested data is transmitted via the TCP/IP channel 131 and placed in the database 103 which contains profile and image data for all nearby peer players. A periodic check of the peer list 137 may be performed to identify players whose presence has not been detected for a predetermined time, and the profile and image data relating to these departed players may then be purged (or marked as being eligible for erasure) to conserve memory space. The player that transmits image and profile data may first request information concerning the requesting player and then respond with profile and image data only to the extent indicated by the permissions given by its user.

If a received UDP packet is not an announcement packet, a test is then performed (by the MP3 listener module seen at 115 in FIG. 1) at 211 to determine if the packet is an MP3 packet. If it is, the packet is stored in the MP3 buffer 114 as indicated at 213. When a user selects a local audio track, the system begins to multicast packets consisting of some timing info, and frames of MP3 data to all interested peers (itself included) using the output multicasting streaming process seen at 124 in FIG. 1. The audio listening process at 115 marshals this data into a buffer from which the MP3 decoder reads. The timing info is used to regulate the contents of the buffer and the requests from the decoder 107 to provide a synchronized audio experience among the peers.

The current software build is deployed on 802.11b enabled HP iPaq 4150's, and has also been tested on HP iPaq 5450's. It is however, designed to run on any Wi-Fi equipped Pocket PC device running Windows CE.Net 4.2, and could be readily extended to function over another wireless standard, such as Bluetooth, or with some modifications on another operating system such as Linux.

Music is stored locally on the device as a series of MP3 encoded files. We have found that audio files using MPEG 1.0 Layer 3, CBR (Constant Bit Rate), 112 kbps, 44.1 kHz Joint-Stereo files provide a good balance between fidelity and compression levels. Audio files can be downloaded to the devices by copying compatible files directly to a storage card (SD/MMC) using an external card reader, or any other normal means of transferring data to the Pocket PC such as ActiveSync, a network share, or any Internet connection.

As described above, tunA uses a ‘beaconing’ approach to detect other devices within range. The discovery subsystem periodically transmits custom UDP multicast packets announcing its presence and some basic peer-related information to all nearby devices, and maintains a list of those peers from whom it has detected similar packets within a specified time frame. This beacon transmission may occur every second, and assume a peer to be out-of-range after a lack of communication for three seconds. RSSI (Received Signal Strength Information), GPS-generated location data, or establishing and testing TCP/IP connections, could be used as alternative mechanisms for identifying and communicating with nearby devices.

The envisaged scenarios for this application (joining a social gathering, sitting on a bus, etc.) require a range of approximately 20-30 meters, which is suitable for local Bluetooth connections. Larger ranges may be used with Wi-Fi ad hoc networks, with the maximum range being heavily dependent on the 802.11 adaptor/antenna used (some of which can communicated at distances of 2700 feet). and could be extended further with Multi-Hop techniques.

The audio streaming multicasting service 124 reads frames of MP3 encoded data from a locally stored file, and transmits them via specially formatted UDP multicast packets, which also include certain timing/synchronization information. When a “tuned in” peer player receives these multicast packets, they are added to the buffer 114 from which the decoding service 107 periodically requests data.

As seen in FIG. 3, the listening mechanism uses a timing mechanism to determine when packets are transmitted to other players via the UDP channel 121. The current time is determined from the system clock as indicated at 301 and the current time is then compared at 303 with the time at which the last MP3 packet was multicast. If the interval exceeds a predetermined interval A, further tests are performed at 305 to determine if the decoder 107 has requested a packet from the player 105 (indicating that the local player is actively playing a song) and whether the peer list at 137 indicates that there is at least one nearby player that has “tuned in” to this player. If both are true, then an MP3 packet is multicast to the listening player as indicated at 307. As noted below under “synchronization,” timing data identifying the particular frame last requested by the local decoder and the time at which the decoder requested that frame is inserted into the header of the broadcast MP3 packet.

The player also periodically transmits a “beacon” signal in the form of a UDP announcement packet as indicated at 133 in FIG. 1. To time the periodic transmission of these announcement packets, the current time obtained at 301 is compared at 309 with the time when the last announcement was sent. It this interval exceeds the duration B as determined at 309, a packet containing an identification of this player is sent to the remote players at 311. The receiving player may then request additional information about the player which will then be transmitted as text or image (e.g., an avatar image) date using the TCP/IP channel 121. This additional information is exchanged under the control of the IM module 132 which confirms that the requested data exchange conforms to the permission and preference data established for both the transmitting and receiving players.

Audio playback is achieved by decoding the MP3 frames stored in the local buffer 114 to raw waveform data, which is fed to the O/S for reproduction via the headphone jack, and optionally the device's internal speaker. Our prototype employed the publicly available FMOD Multiplatform audio library (available at: http://www.finod.org) for this purpose. The default file-handling mechanism of the FMOD library was modified to use the file open/close/seek/tell/read requests to read chunks of MP3 data from the separately maintained buffer 114 instead of from a locally stored file. This particular approach was chosen over several others for the efficiency of the decoding algorithms employed by the FMOD audio library, but several other decoders could be used in its place: the Windows WinCE platform and the Windows Media Player ActiveX control may be employed. In addition, both the MAD (Mpeg Audio Decoder available at: http://www.underbit.com/products/mad) and XAudio (Multiplatform audio library available at http://www.xaudio.com) libraries are also available for WinCE. Significantly, since the current generation of Pocket PC devices do not have hardware FPU's (Floating Point Units), integer based systems such as FMOD and MAD outperform routines using floating-point processing.

Synchronization

The human ear will assume two audio signals are ‘coherent’ (i.e. from the same source) if they arrive within 30 ms of each other. On the Pocket PC platform, this level of synchronization is difficult to maintain over time due to variances in manufacture (audio crystals), clock skew, OEM dependent timing information, unreliable network protocols, and the lack of a real-time operating system. Despite these obstacles, the synchronization algorithms described below have been found to successfully maintain the desired synchronization between source and listening players.

The synchronization method used to insure that each listener is hearing the same thing at the same time is essentially a three-part process, applied for the full duration of the shared audio experience. The timing data used for synchronization is included in the header of the packets of MP3 frames that are multicast as the audio stream.

First, a common reference logical clock or ‘heartbeat’ among all the source and receiving devices is established. This can be accomplished using any of a number of algorithms—for example: Christian's, Berkeley, NTP etc. The Network Time Protocol, described in RFC-1305, is the most commonly used Internet time protocol. The client software runs continuously as a background task that periodically gets updates from one or more servers. The client software ignores responses from servers that appear to be sending the wrong time, and averages the results from those that appear to be correct. The NIST servers listen for a NTP request on port 123, and respond by sending UDP/IP data packets in the NTP format. The data packet includes a 64-bit timestamp containing the time in UTC seconds since Jan. 1, 1900 with a resolution of 200 ps. This reference clock (reporting the global “current time”) can be queried by the software running on each device, as in 401 in FIG. 4.

Next, as indicated at 403, the track position of the source player is computed using information from the buffer 114 about the last frame that the decoder 107 requested, and the time it requested it. This timing information is transmitted to the listening players in the headers of the multicast MP3 packets. These MP3 packets contain audio information that is ahead of the position currently being played on the source player by a predetermined interval in order to make it possible for the listening devices to synchronize to the source playback despite any delays present in the channel

Finally, at the listening player, the incoming MP3 packet is received at 405 and the timing information it contains is compared with the current local playback position at 407. If the local buffer is determined to be out of sync by more than a pre-determined amount with the timing of the source, frames are removed, or blank frames are inserted, to bring the local and remote players into synchronization. Thus, if it is determined that the local playback is ahead of the source playback position at 409, blank frames are inserted at 411 into the frame stream which is sent to satisfy the requests of the local decoder. If the local playback position is lagging the remote playback position as determined at 411, frames received from the source are discarded as indicated at 415.

Alternatively, the frequency of the local player may be dynamically adjusted or other methods applied until timing of the frames sent to the respective decoders matches

Note that, if a given player is reproducing specific program content that is being multicast from a nearby unit, instead of reproducing content from its own internal file storage, and that given player has been tuned in by another player, it acts as a relay device since it determines (at step 305 seen in FIG. 3) that it is both playing a song and being listened to. The timing information from the source player is relayed along with the program content in the multicast packets from the player that is both a listener and a source. As a consequence, a given song may be played on several players using multi-hop connectivity/synchronization: A person (X) might tune into someone else (Y) that in turn is tuned into someone else (Z) who is out of range of the original person (X), and the experience would remain synchronized.

This implementation is one of many possible ways to implement the general synchronization method devised, which involves establishing a global reference clock (using any number of established means) to gain information about the amount of delay in the channel between the source and each receiver, and introducing varying amounts of additional artificial delay at each playback point so that the final delays experienced by each receiver are equal.

User Interface

The tunA player employs a full-screen, “skinnable” user interface, implemented as a set of subdlassed owner-drawn MFC (Microsoft Foundation Classes) controls consisting of ListBoxes, Richlinks, Buttons, Edit boxes, Static text labels, etc). By supplying a set of BMP/GIF images which “decorate” the screen displays, including image data for avatars representing each player, and an ASCII text file describing the location, content and attributes of the images, a user can modify the appearance of these graphical widgets to provide a customized look and feel for the interface.

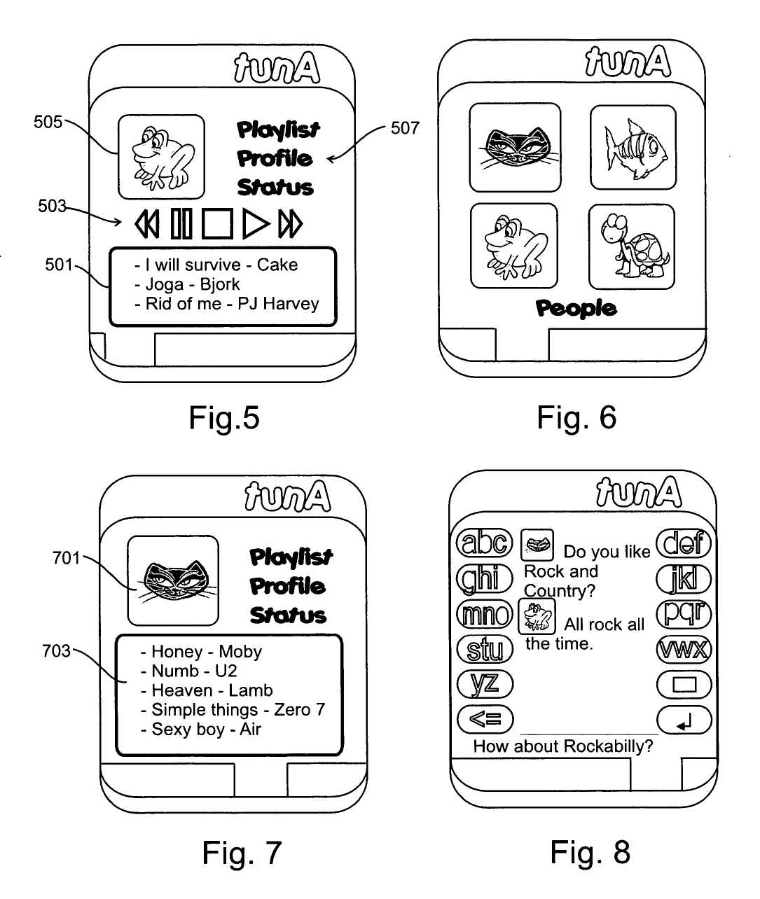

By default, the user interface may be implemented by four tabbed screens, divided by functionality, which are illustrated in FIGS. 5-8.

FIG. 5 shows the screen displayed when the first tab is selected. This screen controls local music playback and includes a list box at 501 which presents a scrollable list of songs that are available in local storage for playback. Additional controls at 503 allow the user to control playback and include conventional controls for pausing, playing, stopping, rewinding, skipping ahead, and skipping to the next or prior song on a playlist. The screen displays the avatar image at 503 which identifies the user of the local player (and displays the avatar of the user operating a different player when that player is being listened to as shown in FIG. 7). By pressing the different labels at 507, the user can display his or her current profile, a list of playlists which can be selected to control playback, and status information describing such things as the number of locally stored songs, the number of nearby players in range, current preference settings, etc

The second tab displays the screen seen in FIG. 6 which displays the avatars of all players that are within range. By touching an avatar, the display automatically switches to the display the screen seen in FIG. 7 which shows the avatar of the listened-to player at 701, and displays an information window at 703 which displays either a playlist from the selected remote player, profile data describing the user of the selected remote player, or status information concerning the remote player (to the extent publication of such information is permitted by the user of the remote player).

When the screen shown in FIG. 7 is displayed, and the window 703 is displaying a playlist of songs available on the remote listened-to player identified by the image 701, the selection of an item on that list transmits a request to the source player being listened to switch the playback to that selected other song. The source player may then display the request to its user who accepts or rejects the request. In this way, with the permission of the user, the song being reproduced by the source player can be remotely controlled by one or more of the listening players. Alternatively, the user of the source player my set preferences that allow remote listeners only to tune in to the currently playing song and not to control the source player. The contents of the playlist displayed to the listening player is the current playlist of the source player. If the user of the source player desires to offer a different playlist, he or she simply switches the active playlist by pressing the “playlist” label seen at 507 to display a list of playlists in window 501, and selects a new active playlist, which can then be transmitted to and displayed by other nearby players who have “tuned in” that source player by pressing its icon/avatar/photograph using the screen shown in FIG. 6.

The fourth screen seen in FIG. 8 provides an IM (Instant Messaging) interface that displays SMS-style text messages recently received from nearby players, along with an avatar identifying the source of message, and permit the player to enter and then broadcast an IM message to nearby users, or to send a message only to a specific user The buttons at the left and right of the instant message area can be used as keypads for entering characters to be transmitted (in the same way that the keypad on a cellular phone is used to enter SMS message text). This screen permits the user to hold the device with two hands and tap the buttons with the fingers on the sides, in order to facilitate the speed of text composition.

Variations

The preferred embodiment of the invention that has been described above takes the form of a hand-held music player that includes a mass storage device for persistently storing copies of music selections and playing these music selections not only to the user of that device but also permitting the same music to be listened to synchronously by the users of other devices who tune in to the source device.

The principals of the invention may also be applied to permit music and other programming which is broadcast to one device from a broadcast station, or streamed to the source device via the Internet, to be listened to by nearby individuals who are tuned to the source device so that they hear the same program content being listened to by the user of the source device. Said another way, the shared content need not be locally stored on the source player but can instead be captured by the source player from an available program source.

The preferred embodiment permits audio programming to be shared, but the principles of the invention are also applicable to the sharing of video and other forms of time-based media content as defined earlier. Note however, that the synchronization of the shared content is particularly important when the content is music, because it is desirable for the listeners, especially when they are nearby each other, to share not only the sounds but also the rhythmic timing in order to have a shared musical experience.

The combination of a messaging system with the music sharing system has a synergistic effect. The messaging system allows information about users and their music to be shared first, which promotes the sharing of music. The sharing of music builds an enjoyable shared experience which promotes the establishment of social relations and hence encourages communications via messaging and sharing of stored profile information. In short, music sharing can be the catalyst for other forms of social communications, and the other forms of communications can provide the environment and personal connections which promote music sharing.

The storage and sharing of profile information (name, contact information, hobbies, interest, etc.) can also facilitate social interactions. Once entered, the profile information can be automatically revealed to others (within the limits established by the user's preference settings, which may be changed depending on the degree of trust the user has in the people known to be in a given gathering). Image data (photographs or avatars) may be used to more easily and visually identify a device user to other nearby users. Information on interests and the characteristics of different users may be used to facilitate contacts. For example, a player may be set to engage in communications and music sharing only with other users who have particular characteristics (age, gender, interests, etc.) and then, when another user who satisfies a specified criteria is nearby, the device automatically alerts the owner and creates the opportunity for social interaction by music sharing and other communications.

Conclusion

It is to be understood that the methods and apparatus which have been described above are merely illustrative applications of the principles of the invention. Numerous modifications may be made by those skilled in the art without departing from the true spirit and scope of the invention.

1. Apparatus for enabling two individuals to listen to the same time-based media program content at the same time comprising, in combination,
a first player for reproducing time-based media program content in a form perceptible to a first user,
a second player for reproducing time-based media program content in a form perceptible to a second user,
a communication channel for transmitting the specific time-based media content being reproduced by said first player to said second player, and
control means in said second player for reproducing said specific time-based media content for said second user at substantially the same time said specific time-based media content is being reproduced by said first player for said first user.

2. Apparatus for enabling two individuals to listen to the same time-based media program content at the same time as set forth in claim 1 wherein said first player includes means for broadcasting an announcement message via said communication channel that identifies said first player to other nearby players, and wherein said second player receives said announcement message and maintains a list of players that are currently nearby.

3. Apparatus for enabling two individuals to listen to the same time-based media program content at the same time as set forth in claim 1 further including means for transmitting information describing said first user from said first player to said second player via said communication channel.

4. Apparatus for enabling two individuals to listen to the same time-based media program content at the same time as set forth in claim 1 wherein said first and second players include means for exchanging identification information via said communication channel.

5. Apparatus for enabling two individuals to listen to the same time-based media program content at the same time as set forth in claim 4 wherein said first and second players further store permission data entered by said first and second users respectively which control the extent to which said identification information is exchanged.

6. Apparatus for enabling two individuals to listen to the same time-based media program content at the same time as set forth in claim 4 wherein said first and second players further include means for exchanging text messages entered by said first and second users respectively.

7. Apparatus for enabling two individuals to listen to the same time-based media program content at the same time as set forth in claim 4 wherein said identification information includes image data portraying said first and second users.

8. Apparatus for enabling two individuals to listen to the same time-based media program content at the same time as set forth in claim 4 wherein said identification information includes information describing said specific time-based media content being reproduced by said first player.

9. Apparatus for enabling two individuals to listen to the same time-based media program content at the same time as set forth in claim 4 wherein said identification information includes information describing time-based media program content which is stored on one or more of said players and is available for transmission to and reproduction by said other players.

10. Apparatus for enabling two individuals to listen to the same time-based media program content at the same time as set forth in claim 1 wherein said communication channel is established between wireless transceivers in said first and second players when said first and second players are within radio range of one another.

11. Apparatus for enabling two individuals to listen to the same time-based media program content at the same time as set forth in claim 10 wherein said wireless transceivers conform to the IEEE 802.11b standard.

12. Apparatus for enabling two individuals to listen to the same time-based media program content at the same time as set forth in claim 10 wherein said wireless transceivers conform to the Bluetooth standard.

13. A music sharing system comprising a plurality of hand-held music players which are interconnected by a wireless communications network, each of said players comprising:
means for selecting another given one of said players, and
means for synchronously reproducing the same music currently being played by said given one of said players.

14. A music sharing system as set forth in claim 13 wherein each of said players further comprises means for displaying and exchanging text messages with one or more other players via said wireless communications network.

15. A music sharing system as set forth in claim 13 wherein each of said players further comprises means for transmitting profile data which describes its user to other players via said wireless communication network.

16. A music sharing system as set forth in claim 15 wherein said means for transmitting profile data includes means for storing preference values accepted from a user and means for preventing the transmission of profile data whose transmission is not authorized by said preference data.

17. A music sharing system as set forth in claim 13 wherein each of said players further comprises means for identifying the presence of other players that are geographically nearby.

18. A music sharing system as set forth in claim 17 wherein said means for identifying the presence of other players that are geographically nearby comprises detecting the receipt via said wireless network of identification messages transmitted by said other players that are geographically nearby.

19. A music sharing system as set forth in claim 17 wherein said means for selecting a given one of said players
comprises means for displaying information identifying said other players that are geographically nearby.

20. A music sharing system as set forth in claim 13 wherein said means for synchronously reproducing the same music currently being played by said given one of said players includes means for receiving timing information and music content from said given one of said players and for reproducing said music content at times indicated by said timing information.
